(19) United States
(12) Patent Application Publication
(10) Pub. No.: US 2011/0166046 A1
(43) Pub. Date: Jul. 7, 2011

(54) UV Light Treatment Methods and System

(76) Inventors: Jimmie D. Weaver, Duncan, OK (US); Johanna A. Haggstrom, Duncan, OK (US)

(21) Appl. No.: 12/683,343

(22) Filed: Jan. 6, 2010

(51) Int. Cl. C09K 8/02

(52) U.S. Cl. 507/101; 507/201

(57) ABSTRACT

Of the many methods provided herein, one provided is a method comprising: providing a treatment fluid having a first microorganism count as a result of the presence of at least a plurality of microorganisms in the fluid; adding an attenuating agent to the treatment fluid; placing the treatment fluid in a UV light treatment system comprising a UV light source such that a plurality of free radicals are generated by the attenuating agent; allowing the free radicals to interact with the microorganisms in the fluid so as to reduce the microorganism count of the treatment fluid to a second microorganism count; and placing the treatment fluid having the second microorganism count into a subterranean formation.

### CROSS REFERENCE TO RELATED APPLICATIONS

The present invention is related to co-pending U.S. application Ser. No. ______ [Attorney Docket No. HES 2008-IP-015679] entitled “Mobile UV light Disinfection System and Methods” filed concurrently herewith, the entire disclosure of which is incorporated herein by reference.

### BACKGROUND

The present invention relates to methods of killing microorganisms found in fluids used for subterranean well treatments, and more specifically, to the use of ultra violet (UV) light in combination with an attenuating agent to combat biological contamination in fluids for use in such well treatments.

The presence of microorganisms, including bacteria, algae, and the like, in well fluids can lead to contamination of a producing formation, which is undesirable. The term microorganism as used herein refers to living microorganisms unless otherwise stated. For example, the presence of anaerobic bacteria (e.g., sulfate reducing bacteria (“SRB”)) in an oil and/or gas producing formation can cause a variety of problems including the production of sludge or slime, which can reduce the porosity of the formation. In addition, SRB produce hydrogen sulfide, which, even in small quantities, can be problematic. For instance, the presence of hydrogen sulfide in produced oil and gas can cause excessive corrosion to metal tubular goods and surface equipment, and the necessity to remove hydrogen sulfide from gas prior to sale. Additionally, the presence of microorganisms in a viscosified treatment fluid can alter the physical properties of the fluids by degrading the viscosifying polymer, leading to a decrease in viscosity, a possible significant reduction in fluid productivity, and negative economic return.

Microorganisms may be present in well fluids as a result of contaminations that are present initially in the base fluid that is used in the fluid or as a result of the recycling/reuse of a well fluid to be used as a base fluid for a treatment fluid or as a treatment fluid itself. In either event, the water can be contaminated with a plethora of microorganisms. In the recycle type of scenarios, the microorganisms may be more difficult to kill.

Biocides are commonly used to counteract biological contamination. The term “biological contamination,” as used herein, may refer to any living microorganism and/or by-product of a living microorganism found in fluids used in well treatments. For well bore use, commonly used biocides are any of the various commercially available biocides that kill mircroorganisms upon contact, and which are compatible with the fluids utilized and the components of the formation. In order for a biocide to be compatible and effective, it should be stable, and preferably, it should not react with or adversely affect components of the fluid or formation. Incompatibility of a biocide in a well bore treatment fluid can be a problem, leading to fluid instability and potential failure. Biocides may comprise quaternary ammonium compounds, chlorine, hypochlorite solutions, and compounds like sodium dichloro-s-triazinetrione. An example of a biocide that may be used in subterranean applications is glutaraldehyde.

Because biocides are intended to kill living organisms, many biocidal products pose significant risks to human health and welfare. In some cases, this is due to the high reactivity of the biocides. As a result, their use is heavily regulated. Moreover, great care is advised when handling biocides and appropriate protective clothing and equipment should be used. Storage of the biocides also may be an important consideration.

High intensity ultra violet (UV) light has been used to kill bacteria in aqueous liquids. The rate at which UV light kills microorganisms in a fluid is a function of various factors including, but not limited to, the time of exposure and flux (i.e., intensity) to which the microorganisms are subjected. For example, in a flow through cell type embodiment, a problem associated with conventional UV light treatment systems is that inadequate penetration of the UV light into an opaque fluid may result in an inadequate kill. Additionally, in such situations, to achieve optimal results, it is desirable to maintain the exposure to UV light at a sufficient flux for as long a period of time as possible to maximize the degree of penetration so that the biocidal effect produced by the UV light treatment may be increased. Another challenge is the turbidity of the fluid. “Turbidity,” as that term is used herein, is the cloudiness or haziness of a treatment fluid caused by individual particles (e.g., suspended solids) and other contributing factors that may be generally invisible to the naked eye. The measurement of turbidity is a key test of water quality. The partial killing of the bacteria results in the re-occurrence of the contamination which is highly undesirable in the subterranean formation as discussed above.

### SUMMARY

The present invention relates to methods of killing microorganisms found in fluids used for subterranean well treatments, and more specifically, to the use of UV light in combination with an attenuating agent to combat biological contamination in fluids for use in such well treatments.

In one aspect, the present invention provides a method comprising: providing a treatment fluid having a first microorganism count as a result of the presence of at least a plurality of microorganisms in the fluid; adding an attenuating agent to the treatment fluid; placing the treatment fluid in a UV light treatment system comprising a UV light source such that a plurality of free radicals are generated by the attenuating agent; allowing the free radicals to interact with the microorganisms in the fluid so as to reduce the microorganism count of the treatment fluid to a second microorganism count; and placing the treatment fluid having the second microorganism count into a subterranean formation.

In one aspect, the present invention provides a method comprising: providing a treatment fluid having a first microorganism count as a result of the presence of at least a plurality of microorganisms in the fluid; adding an attenuating agent to the treatment fluid; placing the treatment fluid in a UV light treatment system comprising a UV light source such that a plurality of free radicals are generated by the attenuating agent; and allowing the free radicals to interact with the microorganisms in the fluid so as to reduce the microorganism count of the treatment fluid to a second microorganism count.

In one aspect, the present invention provides a method comprising: providing a treatment fluid having a first microorganism count as a result of the presence of at least a plurality of microorganisms in the fluid; adding an attenuating agent and a chemical biocide to the treatment fluid; placing the treatment fluid in a UV light treatment system comprising a UV light source such that a plurality of free radicals are generated by the attenuating agent; allowing the free radicals and the chemical biocide to interact with the microorganisms in the fluid so as to reduce the microorganism count of the treatment fluid to a second microorganism count; and placing the treatment fluid having the second microorganism a nanosized manganese oxide, count into a subterranean formation.

The features and advantages of the present invention will be readily apparent to those skilled in the art. While numerous changes may be made by those skilled in the art, such changes are within the spirit of the invention.

### BRIEF DESCRIPTION OF DRAWINGS

These drawings illustrate certain aspects of some of the embodiments of the present invention, and should not be used to limit or define the invention.

FIG. 1 illustrates a schematic of a system that may be used in conjunction with one embodiment of the present invention.

While the present invention is susceptible to various modifications and alternative forms, a specific exemplary embodiment thereof has been shown by way of example in the drawing and is herein described in detail. It should be understood, however, that the description herein of specific embodiments is not intended to limit the invention to the particular form disclosed, but on the contrary, the intention is to cover all modifications, equivalents and alternatives falling within the spirit and scope of the invention as defined by the appended claims.

### DESCRIPTION OF PREFERRED EMBODIMENTS

The present invention relates to methods of killing microorganisms found in fluids used for subterranean well treatments, and more specifically, to the use of UV light in combination with an attenuating agent to combat biological contamination in fluids for use in such well treatments. The term “attenuating agent” as used herein refers to UV sensitive photoinitiator compounds that are labile, and that on exposure to UV light, decompose to form free radicals that can kill microorganisms.

Among the many potential advantages of the present invention, is the ability to combat biological contamination in well fluids without relying on biocides that can bring their own set of complications. One of the more important benefits may be that a near complete killing of the bacteria and microorganisms in well treating fluids may be obtained, under certain embodiments. The UV light fluid treatment systems of the present invention may have a much greater biocidal effect than conventional systems, and may achieve deeper penetration into the fluid and a more complete kill of the biological contamination found therein. This may permit fluids to be reclaimed and re-used in oilfield operations. Also, the systems present little or no chemical concerns according to current (at the time of filing) environmental laws and regulations. These systems may allow for the diminished need for a high flux UV light source or increased exposure in some embodiments, especially as compared to typical UV light fluid treatment systems.

One of the benefits of the present invention is that timing of treatment may be carefully chosen to best fit a desired application. To initiate treatment, the attenuating agents should be exposed to the UV light source to facilitate the release of free radicals. Another benefit may be that the free radical initiators may not biocidal until they are activated by the UV light source and so they may be kept in the fluids until contamination is present and then activated to control bacterial growth. This delayed generation of biocides through the reaction of UV light and free radical forming material allows for controlled placement of the fluid and alleviates handling and exposure concerns often associated with the use of conventional chemical biocides.

Attenuating agents of the present invention may be used in combination with a UV light source to decrease the necessity of long and repeated exposures to high power UV lights. The attenuating agents are thought to effectively prolong the effect of the UV light and its reaction with the microorganisms. It is well understood that, when photoinitiators are exposed to a UV light source, even at low levels, they photoisomerize to release free radicals. The free radicals may then act to decompose microorganisms (e.g., bacterial membranes) within the fluid. Also, longer biocidal action should be realized at least in most embodiments by selecting the appropriate free-radical-forming material based on solubility, reactivity and free radical half-life. Additionally, the UV light fluid treatment systems of the present invention should effectively generate long-lasting free radicals so that even after the treatment, biocidal action may be stimulated in the fluids used in well treatments, thus continuing to kill bacteria, and remove contamination to recover production in formations.

In one embodiment, the present invention comprises a method comprising: providing a treatment fluid having a first microorganism count as a result of the presence of at least a plurality of microorganisms in the fluid; adding an attenuating agent to the treatment fluid; placing the treatment fluid in a UV light treatment system comprising a UV light source; allowing a plurality of free radicals to be generated from the attenuating agent; allowing the free radicals to interact with the microorganisms in the fluid so as to reduce the first microorganism count of the treatment fluid to a second microorganism count; and placing the treatment fluid having the second microorganism count into a subterranean formation. In some embodiments, the first microorganism count is 10¹⁰ bacteria/mL, and the second microorganism count may be a log₅ reduction of that count.

The attenuating agents of the present invention can be introduced into any suitable treatment fluid that is applicable to the chosen operation. The compositions and methods of the present invention may be useful for any subterranean treatment fluid. Examples of suitable treatment fluids include any known subterranean treatment fluid, including those in high volume, (e.g., drilling and fracturing fluids), and those that are lower in volume (e.g., pills). Nonlimiting examples of the types of suitable treatment fluids include, but are not limited to, aqueous-based fluids, brines, foams, gases and combinations thereof (such as emulsions). Suitable treatment fluids for the present invention may comprise virgin fluids (e.g., those that have not been used previously in a subterranean operation) and/or recycled fluids. Virgin fluids may contain water directly derived from a pond or other natural source. Recycled fluids may include those that have been used in a previous subterranean operation, such as, but not limited to, produced water and flowback water. In certain embodiments, the virgin fluids may be contaminated with a plethora of microorganisms, having an initial microorganism count in the range of about 10³ to about to 10³⁰ bacteria/mL. In some embodiments, 10¹⁰ bacteria/mL or greater may be common. Recycled fluids may be similarly contaminated as a result of having been previously used in a subterranean formation or stored on-site in a contaminated tank or pit. Recycled fluids may have a first microorganism count in the same range, but it may have a different bacterial contamination in that it may comprise different bacteria that are harder to kill than those that are usually present in virgin fluids.

Suitable attenuating agents for use in the fluids and methods of the present invention include organic and inorganic attenuating agents. The solubility and/or dispersability of an attenuating agent may be a consideration when deciding whether to use a particular type of attenuating agent. Some of the agents may be modified to have the desired degree of solubility or dispersability. Cost and environmental considerations might also play a role in deciding which to use. Also, the method of use in the methods of the present invention may be a factor as well. For example, some methods may call for a less soluble agent whereas others may be more dependent on the solubility of the agent in the treatment fluid. The particular attenuating agent used in any particular embodiment depends on the particular free radical desired and the properties associated with that free radical. Some factors that may be considered in deciding which of the attenuating agents to use include, but are not limited to, the stability, persistence and reactivity of the generated free radical. The desired stability also depends on the amount of contamination present and the compatibility the free radicals have with the fluid composition. To choose the right attenuating agent for treatment, one should balance stability, reactivity and incompatibility concerns. Those of ordinary skill in the art with the benefit of this disclosure will be able to choose an appropriate attenuating agent based on these concerns.

Suitable organic attenuating agents for use in the present invention, include, but are not limited to, one or more water-soluble photoinitiators that undergo cleavage of a unimolecular bond in response to UV light and release free radicals. Under suitable conditions and appropriate exposure to UV light, the attenuating agents of the present invention will yield free radicals, such as in the example of Scheme 1 below:

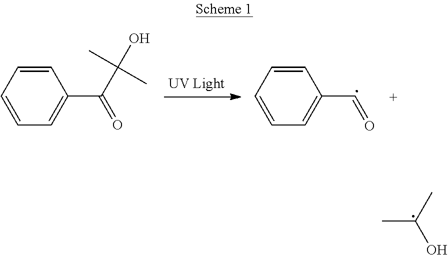

Suitable photoinitiators may be activated by the entire spectrum of UV light, and may be more active in the wavelength range of about 250-500 nm. The molecular structure of the attenuating agent will dictate which wavelength range will be most suitable. Some photoinitiators undergo cleavage of a single bond and release free radicals. Each organic photoinitiator has a life span that is unique to that photoinitiator. Generally, the less stable the free radical formed from the photoinitiator the shorter half life and life span it will have.

Suitable organic photoinitiators for use in the present invention may include, but are not limited to, acetophenone, propiophenone, benzophenone, xanthone, thioxanthone, fluorenone, benzaldehyde, anthraquinone, carbazole, thioindigoid dyes, phosphine oxides, ketones, and any combination and derivative thereof. Some photoinitiators include, but are not limited to, benzoinethers, benzilketals, alpha-dialkoxyacetophenones, alpha-hydroxyalkylphenones, alpha-aminoalkylphenones, and acylphosphineoxides; any combination or derivative thereof. Other photoinitiators undergo a molecular reaction with a secondary molecule or co-initiator, which generates free radicals. Some additional photoinitiators include, but are not limited to, benzophenones, benzoamines, thioxanthones, thioamines; any combination or derivative thereof. These materials may be derivatized to improve their solubility with a suitable derivatizing agent. Ethylene oxide, for example, may be used to modify these photoinitiators to increase their solubility in a chosen treatment fluid. Such photoinitiators may absorb the UV light and undergo a reaction to produce a reactive species of free radicals (See Scheme 1, for instance) that may in turn trigger or catalyze desired chemical reactions.

In certain embodiments, free radicals released through the activation of photoinitiators initiate damage to living microorganisms. In certain embodiments, the mode of action for the photoinitiators may be the interaction of the released free radicals with the microorganisms so as to disrupt the cellular structures and processes of the microorganism. In some instances, the biocidal effect due to prolonged life associated with each free radical is thought to increase with increasing free radical stability and reactivity. For certain aspects of the present invention, it may be important to choose an attenuating agent to consider the life span or half life of the free radicals that will result. Some free radicals may be very active even though they have short life span. Some free radicals may be more active in the presence of the UV light whereas some may retain the activity even outside direct exposure to the UV light. The term “half-life” as used herein refers to the time it takes for half of the original amount of the free radicals generated to decay. The term “life span” refers to the total time for the free radical to decay almost completely. For instance, a free radical with a longer half life will result in a longer lasting biocidal effect, limiting the need for UV light exposure and therefore, may be more useful in fluids having a high turbidity.

Alternatively, inorganic attenuating agents may be used in certain embodiments. When exposed to UV light, these agents will generate free radicals that will interact with the microorganisms as well as other organics in a given treatment fluid. In preferred embodiments, these may include nanosized metal oxides (e.g., those that have at least one dimension that is 1 nm to 1000 nm in size). In some instances, these inorganic nanosized metal oxide attenuating agents may agglomerate to form particles that are micro-sized. Considerations that should be taken into account when deciding the size that should be chosen include a balance of surface reactivity and cost. Examples of suitable inorganic attenuating agents include, but are not limited to, nanosized titanium dioxide, nanosized iron oxides, nanosized cobalt oxides, nanosized chromium oxides, nanosized magnesium oxides, nanosized aluminum oxides, nanosized copper oxides, nanosized zinc oxides, nanosized manganese oxides, and any combination or derivative thereof. Titanium dioxide, for example produces hydroxyl radicals upon exposure to UV light. These hydroxyl radicals, in one mechanism, are very useful in combating organic contaminants. These reactions can generate CO₂. Nanosized particles are used because they have an extremely small size maximizing their total surface area and resulting in the highest possible biocidal effect per unit size. As a result, nanosized particles of metal oxides provide a higher enhancement of kill rate efficiency than larger particles used in much higher concentrations. An advantage of using such nanosized metal oxide particles in combating contamination is that the treated microorganisms can not acquire resistance to such metal particles, as commonly seen with other biocides.

In some embodiments, the inorganic attenuating agents can be added as solid particles to a treatment fluid. In other embodiments, the inorganic attenuating agents may be used in a suspension form, e.g., in water. This might be useful when it is desirable to coat an element of a UV device in which the UV light will be used. In an alternative embodiment, a thin film of the nanosized metal oxide may be placed on the UV apparatus that is being used in a given system, for example, on the quartz sleeve that encases the UV bulbs. An advantage of using a thin film in such a manner is that the system becomes self-cleaning.

The concentration of the attenuating agent used in the treatment fluids of the present invention may range up to about 5% by weight of the fluid. The particular concentration used in any particular embodiment depends on what free radical compound is being used, and magnitude of contamination that is present in the turbid treatment fluid. Other complex, interrelated factors that may be considered in deciding how much of the attenuating agent to include are, but are not limited to, the composition contaminants present in the fluid (e.g., scale, skin, calcium carbonate, silicates, and the like), the particular free radical generated, the expected contact time of the formed free radicals with the bacteria, etc. The desired contact time also depends on the amount of contamination present and the compatibility the free radicals have with the fluid composition. For instance, to avoid incompatibility, it may be desirable to treat the water source prior to mixing in with the other components of the treatable fluids. A person of ordinary skill in the art, with the benefit of this disclosure, will be able to identify the type of attenuating agents as well as the appropriate concentration to be used.

Many attenuating agents are liquids, and can be made to be water soluble or water insoluble. Similarly, attenuating agents may exist in solid form, and can be made to be water soluble and water insoluble.

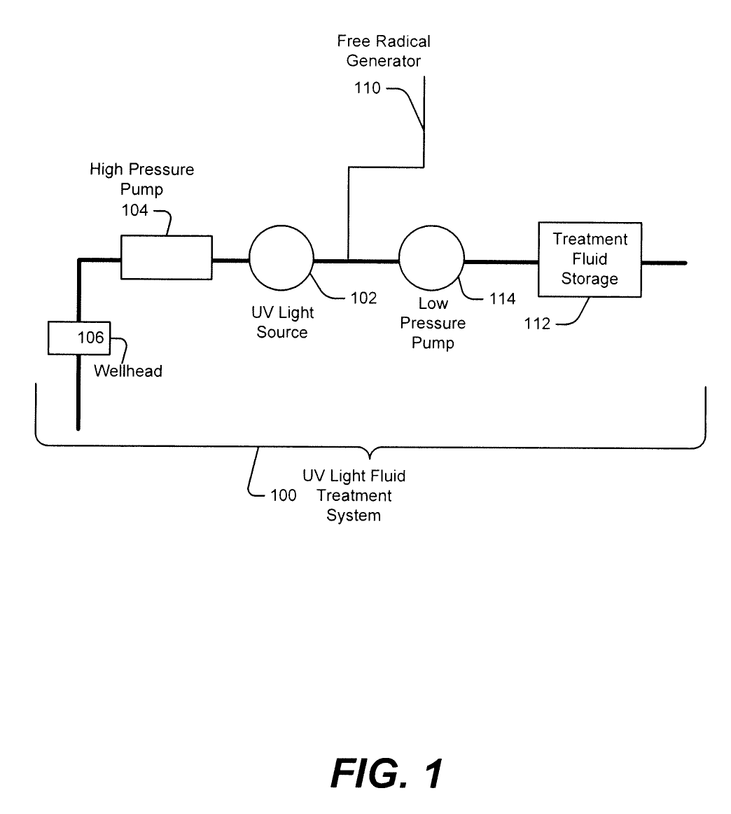

Referring to FIG. 1, an optional UV light fluid treatment system 100 is shown that may be used to disinfect water or other treatment fluids that may be used in well bore operations in accordance with the present invention. As used herein, the term “disinfect” shall mean to reduce the number of bacteria and other microorganisms found in the aqueous fluid. In the embodiment of FIG. 1, the UV light fluid treatment system 100 may comprise one or more UV light sources 102, a high-pressure pump 104, a treatment fluid, and an attenuator 110. The treatment fluid 106 may be stored in a storage container 112. The treatment fluid, which need not be treated water, but instead may be untreated produced or returned water, or other types of fluid used in well bore operations. In some embodiments, the free radical generators 110 are added to the treatment fluids prior to placing the fluids through the high-pressure pump 104. The treatment fluids may be passed through a low pressure pump 114 while passing the UV light source 102 to increase the biocidal effect and eliminate the contamination, by increasing the turbulence with a low pressure pump this allows more of the fluid to be exposed to the UV light when dealing with turbid fluids. Both the power of the UV light source and the duration to which the fluids are exposed to the UV light are decreased in the present invention.

In another embodiment, the free radical generators 110 and UV light exposure by the UV light source 102 occurs at the fluid storage container 112 or at the fluid source, prior to placement in the high-pressure pump 104. This system provides a method wherein the difficulty of utilizing a UV light source 102 within the subterranean formation is eliminated, since the treatment fluid is pre-treated prior to use in well treatment fluids.

In yet another embodiment, the treatment fluid may be reclaimed and then treated to eliminate contamination prior to storage and re-use. This method allows the production of re-usable fluids, thereby conserving the sparse water supply.

High-pressure pumps in the present invention may be of any type suitable for moving fluid and compatible with the fluids used. High-pressure pumps may pressurize the fluid. In some embodiments, the pumps may be staged centrifugal pumps, or positive displacement pumps, but other types of pumps may also be appropriate. After passing through the pumps, the treatment fluid may join proppant particulates, gels, and other chemical additives. In some embodiments, the treatment fluid may comprise these additives prior to passing through the high-pressure pump. The treatment fluid may then move through the wellhead 106 and downhole to a perforated zone to perform the desired subterranean operation.

The pump rates in embodiments of the present invention, may be increased, by the addition of free radical generators in the treatment fluids. The rate increase depends both on the nature of the contamination and the effectiveness of the free radical formed. The present invention also provides the possibility of decreasing the power demand by reducing the amount of UV light necessary to eliminate the contamination. Due to the turbidity of the fluids, the amount of UV light that actually passes through and penetrates the fluid is low and usually results in an incomplete kill. The present invention provides a method where relatively very little UV light is necessary versus conventional systems to have a substantial biocidal effect by taking advantage of free radical forming compounds.

The treatment fluid comprising the attenuating agents may be exposed to the UV light source before being introduced to the subterranean formation. Suitable UV light sources for use with the present invention may include any radiation source suitable for use in subterranean applications, including, but not limited to, UV light, sunlight, artificial light, and the like. Mercury vapor, xenon and tungsten lamps are examples of suitable radiation light sources. In some embodiments, the UV light treatment source may comprise one or more germicidal UV light sources in a series or in parallel. The entire range of UV light may be suitable.

In some embodiments, the system according to the present invention may use low to medium pressure germicidal UV lamps configured and functioning. Ultraviolet light is classified into three wavelength ranges: UV-C, from about 200 nanometers (nm) to about 280 nm; UV-B, from about 280 nm to about 315 nm; and UV-A, from about 315 nm to about 400 nm. Generally, UV light, and in particular, UV-C light is germicidal. Germicidal, as used herein, generally refers to eliminating bacteria and other microorganisms. Specifically, UV-C light causes damage to the nucleic acid of microorganisms by forming covalent bonds between certain adjacent bases in the DNA. The formation of these bonds prevents the DNA from being “unzipped” for replication, and the organism is unable to produce molecules essential for life process, nor is it able to reproduce. In fact, when an organism is unable to produce these essential molecules or is unable to replicate, it dies. UV light with a wavelength of approximately between about 250 nm to about 260 nm provides the highest germicidal effectiveness.

While the susceptibility of the microorganisms to UV light and the free radicals formed varies depending on volume and properties of the treatment fluid as well the amount and properties of the photoinitiator added, a person of ordinary skill in the art with the benefit of this disclosure would be able to optimize the conditions necessary to adequately deactivate over 90 percent of microorganisms found in the treatment fluid. In certain embodiments of the present invention, a broad range of UV light wavelengths may be used, including but not limited to the range of about 250 nm to about 500 nm, with preferred range of about 250 nm to 400 nm.

The treatment fluids of the present invention may comprise any additives that may be needed for the fluid to perform the desired function or task, providing that these additives do not negatively interact with the degradable diverting agents of the present invention. Such additives may include gelling agents, gel stabilizers, salts, pH-adjusting agents, corrosion inhibitors, dispersants, flocculants, acids, foaming agents, antifoaming agents, H₂S scavengers, lubricants, particulates (e.g., proppant or gravel), bridging agents, weighting agents, scale inhibitors, biocides, friction reducers, and the like. Suitable additives for a given application will be known to one of ordinary skill in the art. In certain embodiments, the addition of such additives to the treatment fluids of the present invention may be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing. In some embodiments of the present invention, these suitable additives may be mixed into the treatment fluid comprising the attenuating agents of the present invention on the fly.

In certain embodiments, optionally, when conditions indicate that effective UV light disinfection of the treatment fluids comprising the free radical generators is not enough, chemical biocides may be added to increase the disinfection power. Suitable chemical biocides for use in the present invention may include any chemical biocide that is suitable for use in a subterranean application. Minimal or no use of such chemical biocides is preferred.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a treatment fluid having a first microorganism count as a result of the presence of at least a plurality of microorganisms in the fluid;
adding an attenuating agent to the treatment fluid;
placing the treatment fluid in a UV light treatment system comprising a UV light source such that a plurality of free radicals are generated by the attenuating agent;
allowing the free radicals to interact with the microorganisms in the fluid so as to reduce the microorganism count of the treatment fluid to a second microorganism count; and
placing the treatment fluid having the second microorganism count into a subterranean formation.

2. The method of claim 1 wherein the treatment fluid is a drilling fluid, a fracturing fluid, a pill, an aqueous based fluid, a brine, or a foamed fluid.

3. The method of claim 1 wherein the treatment fluid comprises a virgin fluid or a recycled fluid.

4. The method of claim 1 wherein the first microorganism count is in the range of about 10³ to about 10³⁰ bacteria/mL.

5. The method of claim 4 wherein the second microorganism count is a log₅ reduction of the first microorganism count.

6. The method of claim 1 wherein the attenuating agent is an organic attenuating agent chosen from the group consisting of: acetophenone, propiophenone, benzophenone, xanthone, thioxanthone, fluorenone, benzaldehyde, anthraquinone, carbazole, a thioindigoid dye, a phosphine oxide, a ketone, benzoinethers, benzilketals, an alpha-dialkoxyacetophenone, an alpha-hydroxyalkylphenone, an alpha-aminoalkylphenone, an acylphosphineoxide, a benzophenone, a benzoamine, a thioxanthone, a thioamine, any combination thereof, and any derivative thereof.

7. The method of claim 1 wherein the attenuating agent is an inorganic attenuating agent chosen from the group consisting of: a nanosized titanium dioxide, a nanosized iron oxide, a nanosized cobalt oxide, a nanosized chromium oxide, a nanosized magnesium oxide, a nanosized aluminum oxide, a nanosized copper oxide, a nanosized zinc oxide, a nanosized manganese oxide, any combination thereof, and any derivative thereof.

8. The method of claim 1 wherein the UV light treatment system comprises a UV light in the wavelength range of about 250 to about 500 nm.

9. The method of claim 1 wherein the UV light treatment system comprises a UV bulb and at least a portion of the attenuating agent is an inorganic attenuating agent that is placed on a least a portion of the bulb.

10. The method of claim 1 wherein the concentration of the attenuating agent in the treatment fluid is up to about 5% by weight of the treatment fluid.

11. The method of claim 1 wherein the treatment fluid comprises an additive chosen from the group consisting of: a gelling agent, a gel stabilizer, a salt, a pH-adjusting agent, a corrosion inhibitor, a dispersant, a flocculant, an acid, a foaming agent, an antifoaming agent, an H₂S scavenger, a lubricant, a particulate, a bridging agent, a weighting agent, a scale inhibitor, a chemical biocide, a friction reducer, any combination thereof, and any derivative thereof.

12. A method comprising:
providing a treatment fluid having a first microorganism count as a result of the presence of at least a plurality of microorganisms in the fluid;
adding an attenuating agent to the treatment fluid;
placing the treatment fluid in a UV light treatment system comprising a UV light source such that a plurality of free radicals are generated by the attenuating agent; and
allowing the free radicals to interact with the microorganisms in the fluid so as to reduce the microorganism count of the treatment fluid to a second microorganism count.

13. The method of claim 12 further comprising placing the treatment fluid having the second microorganism count into a storage container for later re-use.

14. The method of claim 12 further comprising placing the treatment fluid into a subterranean formation.

15. The method of claim 12 wherein the attenuating agent is an organic attenuating agent chosen from the group consisting of: acetophenone, propiophenone, benzophenone, xanthone, thioxanthone, fluorenone, benzaldehyde, anthraquinone, carbazole, a thioindigoid dye, a phosphine oxide, a ketone, benzoinethers, benzilketals, an alpha-dialkoxyacetophenone, an alpha-hydroxyalkylphenone, an alpha-aminoalkylphenone, an acylphosphineoxide, a benzophenone, a benzoamine, a thioxanthone, a thioamine, any combination thereof, and any derivative thereof.

16. The method of claim 12 wherein the attenuating agent is an inorganic attenuating agent chosen from the group consisting of: a nanosized titanium dioxide, a nanosized iron oxide, a nanosized cobalt oxide, a nanosized chromium oxide, a nanosized magnesium oxide, a nanosized aluminum oxide, a nanosized copper oxide, a nanosized zinc oxide, a nanosized manganese oxide, any combination thereof, and any derivative thereof.

17. The method of claim 12 wherein the second microorganism count is a log₅ reduction of the first microorganism count.

18. A method comprising:
providing a treatment fluid having a first microorganism count as a result of the presence of at least a plurality of microorganisms in the fluid;
adding an attenuating agent and a chemical biocide to the treatment fluid;
placing the treatment fluid in a UV light treatment system comprising a UV light source such that a plurality of free radicals are generated by the attenuating agent;
allowing the free radicals and the chemical biocide to interact with the microorganisms in the fluid so as to reduce the microorganism count of the treatment fluid to a second microorganism count; and
placing the treatment fluid having the second microorganism count into a subterranean formation.

19. The method of claim 18 wherein the attenuating agent is an organic attenuating agent chosen from the group consisting of: acetophenone, propiophenone, benzophenone, xanthone, thioxanthone, fluorenone, benzaldehyde, anthraquinone, carbazole, a thioindigoid dye, a phosphine oxide, a ketone, benzoinethers, benzilketals, an alpha-dialkoxyacetophenone, an alpha-hydroxyalkylphenone, an alpha-aminoalkylphenone, an acylphosphineoxide, a benzophenone, a benzoamine, a thioxanthone, a thioamine, any combination thereof, and any derivative thereof.

20. The method of claim 18 wherein the attenuating agent is an inorganic attenuating agent chosen from the group consisting of: a nanosized titanium dioxide, a nanosized iron oxide, a nanosized cobalt oxide, a nanosized chromium oxide, a nanosized magnesium oxide, a nanosized aluminum oxide, a nanosized copper oxide, a nanosized zinc oxide, a nanosized manganese oxide, any combination thereof, and any derivative thereof.
